(19) United States
(12) Patent Application Publication
(10) Pub. No.: US 2026/0322831 A1
(43) Pub. Date: Oct. 15, 2026

(54) ABNORMALITY DETECTION DEVICE, ABNORMALITY DETECTION METHOD, AND RECORDING MEDIUM

(71) Applicant: NEC Corporation, Tokyo (JP)

(72) Inventors: Shuichi Karino, Tokyo (JP); Tomoo Adachi, Tokyo (JP); Nobuyoshi Tanaka, Tokyo (JP); Ryusel Fuji, Tokyo (JP)

(73) Assignee: NEC Corporation, Tokyo (JP)

(21) Appl. No.: 19/635,988

(22) Filed: Apr. 1, 2026

(30) Foreign Application Priority Data
Apr. 11, 2025 (JP) 2025-065357

(51) Int. Cl. H04L 9/40; H04L 41/16

(52) U.S. Cl. CPC H04L 63/1416; H04L 41/16

(57) ABSTRACT

An abnormality detection device includes at least one memory storing instructions, and at least one processor configured to execute the instructions to, acquire a log accumulated including a login history and a command history, acquire a detection result of an abnormality in the log by using a model in which a normal operation has been learned based on a past normal log, identify a meaning indicated by the abnormality for login related to the abnormality based on the detection result and the login history, and output the login related to the abnormality and the meaning indicated by the abnormality in association with each other.

This application is based upon and claims the benefit of priority from Japanese Patent Application No. 2025-065357, filed on April 11, 2025, the disclosure of which is incorporated herein in its entirety by reference.

### TECHNICAL FIELD

The present disclosure relates to an abnormality detection device, an abnormality detection system, an abnormality detection method, and a program.

### BACKGROUND ART

There is a technique of detecting unauthorized access to a network by monitoring access to a network device.

WO 2023/275995 A1 describes a fraud detection system that detects fraud of a user based on behavior information regarding behavior of the user who has logged in to a service.

### SUMMARY

However, in WO 2023/275995 A1, for example, it may be difficult for a monitoring person of a network device to grasp a reason why an abnormality such as fraud is detected.

An object of the present disclosure is to provide an abnormality detection device or the like that can present a reason why an abnormality is detected.

An abnormality detection device according to one aspect of the present disclosure includes an acquisition means for acquiring a log accumulated including a login history and a command history, an analysis means for acquiring a detection result of an abnormality in the log by using a model in which a normal operation has been learned based on a past normal log, a identification means for identifying a meaning indicated by the abnormality for login related to the abnormality based on the detection result and the login history, and an output means for outputting the login related to the abnormality and the meaning indicated by the abnormality in association with each other.

An abnormality detection system according to one aspect of the present disclosure includes an acquisition means for acquiring a log accumulated including a login history and a command history, an analysis means for acquiring a detection result of an abnormality in the log by using a model in which a normal operation has been learned based on a past normal log, a identification means for identifying a meaning indicated by the abnormality for login related to the abnormality based on the detection result and the login history, and an output means for outputting the login related to the abnormality and the meaning indicated by the abnormality in association with each other.

An abnormality detection method according to one aspect of the present disclosure includes acquiring a log accumulated including a login history and a command history, acquiring a detection result of an abnormality in the log by using a model in which a normal operation has been learned based on a past normal log, identifying a meaning indicated by the abnormality for login related to the abnormality based on the detection result and the login history, and outputting the login related to the abnormality and the meaning indicated by the abnormality in association with each other.

A program according to one aspect of the present disclosure causes a computer to execute processing of acquiring a log accumulated including a login history and a command history, acquiring a detection result of an abnormality in the log by using a model in which a normal operation has been learned based on a past normal log, identifying a meaning indicated by the abnormality for login related to the abnormality based on the detection result and the login history, and outputting the login related to the abnormality and the meaning indicated by the abnormality in association with each other.

Each program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is a first block diagram illustrating an example of a configuration of a system including an abnormality detection device;

FIG. 2 is a diagram illustrating an example of a login history;

FIG. 3 is a diagram illustrating an example of a command history;

FIG. 4 is a diagram illustrating an example of an abnormality detection method and information included in a detection result in a case where an abnormality is detected in each detection method;

FIG. 5 is a diagram illustrating an example of a classification condition, a detection target, and a classification result according to a detection method;

FIG. 6 is a diagram illustrating an example of meaning numbers and meaning information;

FIG. 7 is a diagram illustrating an example of a search condition and a search target according to a meaning indicated by an abnormality;

FIG. 8 is a diagram illustrating an example of a screen on which a login related to an abnormality and a meaning indicated by the abnormality are displayed;

FIG. 9 is a first flowchart illustrating an example of operation of the abnormality detection device;

FIG. 10 is a second block diagram illustrating an example of a configuration of a system including the abnormality detection device;

FIG. 11 is a diagram illustrating an example of login criteria and warning types;

FIG. 12 is a diagram illustrating an example of a screen on which logins that do not satisfy login criteria and the degree of priority displayed in association with each other;

FIG. 13 is a second flowchart illustrating an example of the operation of the abnormality detection device;

FIG. 14 is a block diagram illustrating an example of a configuration of an abnormality detection device;

FIG. 15 is a third flowchart illustrating an example of the operation of the abnormality detection device; and

FIG. 16 is a diagram illustrating an example of a hardware configuration of the abnormality detection device.

### EXAMPLE EMBODIMENT

Hereinafter, example embodiments of the present disclosure will be described in detail with reference to the drawings.

### First Example Embodiment

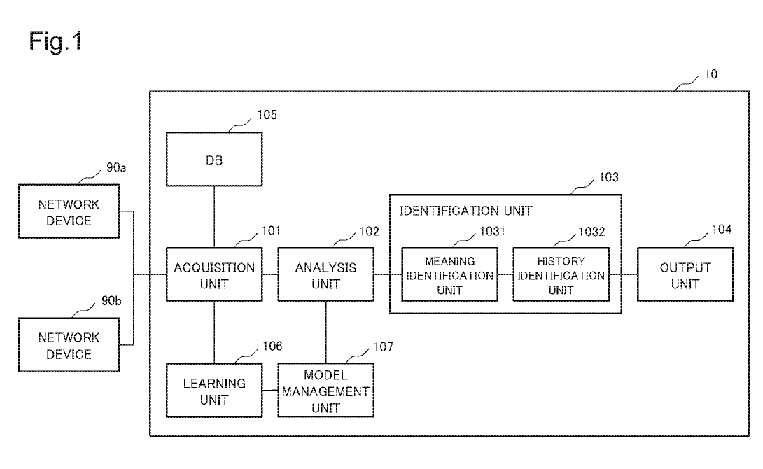

A configuration example of a system including an abnormality detection device 10 will be described with reference to FIG. 1. FIG. 1 is a first block diagram illustrating an example of a configuration of a system including an abnormality detection device. The system includes the abnormality detection device 10 and a network device 90.

The abnormality detection device 10 is connected to the network device 90 via a wired or wireless network. The connection method between the abnormality detection device 10 and the network device 90 is not limited to the wired or wireless network. The abnormality detection device 10 may be connected to the network device 90 by a console cable or the like. In a case where the system includes a plurality of network devices 90, the abnormality detection device 10 is connected to each network device 90 via a wired or wireless network. The abnormality detection device 10 collects an operation history of the network device 90 and monitors an unauthorized operation of the network device 90.

The network device 90 is a device for relaying, transferring, and the like data on a network. The network device 90 has a management function for controlling or monitoring the function of the network device 90 from the outside. A login is set to be necessary to access the management function. The network device 90 has a login function of performing login by collating a user name and a password input by the user. The network device 90 has a login history holding function of holding a login history. The login history is a record of information regarding login. The login history includes information regarding login such as a login time, information for identifying the network device 90 that has performed login, a login result, a user name, and an access source. The information included in the login history is not limited thereto. Furthermore, the network device 90 has a command history holding function of holding a command history. The command history is a record of information regarding a command input to the network device 90. The command history includes a command input time, information for identifying the network device 90 to which the command is input, and information regarding the command such as a command content. The information included in the command history is not limited thereto.

In FIG. 1, the abnormality detection device 10 is connected to two network devices 90 of a network device 90a and a network device 90b. The number of network devices 90 connected to the abnormality detection device 10 is not limited to two. The abnormality detection device 10 can be connected to a plurality of network devices 90 to be monitored.

A configuration of the abnormality detection device 10 will be described with reference to FIG. 1. The abnormality detection device 10 includes an acquisition unit 101, an analysis unit 102, a identification unit 103, and an output unit 104. The identification unit 103 includes a meaning identification unit 1031 and a history identification unit 1032. The abnormality detection device 10 may include a database 105, a learning unit 106, and a model management unit 107.

The acquisition unit 101 is one aspect of an acquisition means for acquiring a log including the accumulated login history and command history.

As described above, the login history is a record of information regarding login. The login history includes information regarding login such as a login time, information for identifying the network device 90 that has performed login, a login result, a user name, and an access source. The information regarding the login included in the login history is not limited thereto. For example, the login history may include a login failure reason in a case where the login result is a login failure. Each piece of information regarding login included in the login history is referred to as a parameter of the login history. The parameter of the login history is an item of information regarding login included in the login history. That is, the login time, the information for identifying the network device 90 that has performed the login, and the information regarding login such as the login result, the user name, and the access source are examples of the parameters of the login history.

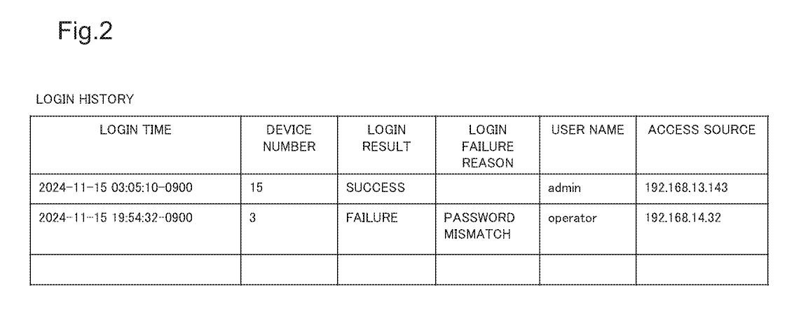

Here, the login history will be described with reference to FIG. 2. FIG. 2 is a diagram illustrating an example of a login history. The login history illustrated as an example in FIG. 2 includes a login time, a device number, a login result, a login failure reason, a user name, and an access source. The device number is a number for identifying the network device 90. The device number is an example of information for identifying the network device 90. The information for identifying the network device 90 is not limited to the device number. In FIG. 2, “success” or “failure” is displayed as the login result. The content of the login result is not limited thereto. The display of the login failure reason and the user name is not limited to the example illustrated in FIG. 2. Further, FIG. 2 illustrates an IP address as an example of an access source. The access source is not limited thereto.

As described above, the command history is a record of information regarding a command input to the network device 90. The command history includes a command input time, information for identifying the network device 90 to which the command is input, and information regarding the command such as a command content. The information regarding the command included in the command history is not limited thereto. Each piece of information regarding the command included in the command history is referred to as a parameter of the command history. The parameter of the command history is an item of information regarding a command included in the command history. That is, the command input time, the information for identifying the network device 90 that has input the command, and the command content are examples of parameters of the command history.

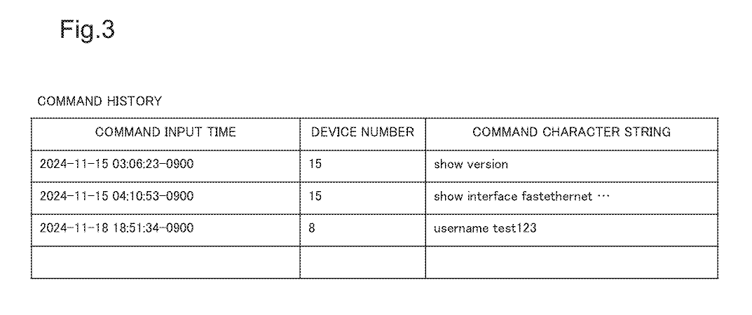

A command history will be described with reference to FIG. 3. FIG. 3 is a diagram illustrating an example of a command history. The command history illustrated as an example in FIG. 3 includes a command input time, a device number, and a command character string. As described above, the device number is an example of information for identifying the network device 90. The information for identifying the network device 90 is not limited to the device number. The command character string is a character string indicating a command content. The command character string is not limited to the notation illustrated in FIG. 3.

The log includes a login history and a command history. That is, the log is an operation history for the network device 90. The operation is a login operation and a command input to the network device 90. The log includes a plurality of parameters. The parameter is an item of information included in an operation history for the network device 90.

Here, the acquisition unit 101 acquires, for example, a log including the login history and the command history accumulated in the database 105. The abnormality detection device 10 includes a database 105. The database 105 is a database in which a log including a login history and a command history is recorded.

The acquisition unit 101 first acquires a login history and a command history from the network device 90. Then, the acquisition unit 101 records the login history and the command history acquired from the network device 90 in the database 105. That is, a log including a login history and a command history is accumulated in the database 105.

Then, the acquisition unit 101 acquires a log including the login history and the command history from the database 105 at a predetermined timing. The predetermined timing is a timing at which log analysis is required to monitor the network device 90. The predetermined timing is set by, for example, a monitoring person of the network device 90. The acquisition unit 101 can acquire a log including a login history and a command history at a certain time every day. The predetermined timing is not limited thereto.

The acquisition unit 101 acquires a login history and a command history in a predetermined time period. The predetermined time period is a time range of a log in which an abnormality is to be detected. For example, in a case where the acquisition unit 101 acquires the login history and the command history every day, the acquisition unit 101 may acquire the login history and the command history for one day every day. That is, the acquisition unit 101 can acquire the login history and the command history for one day every day as the log of the abnormality detection target. The time range of the log acquired by the acquisition unit 101 is not limited thereto.

Here, for example, an information processing device (not illustrated) different from the abnormality detection device 10 may include the database 105. At this time, the abnormality detection device 10 and the information processing device are connected by a wired or wireless network. The acquisition unit 101 transmits the login history and the command history acquired from the network device 90 to the information processing device. The information processing device records the received login history and command history in the database 105. Then, the acquisition unit 101 may acquire the accumulated log including the login history and the command history from the information processing device.

The analysis unit 102 is one aspect of an analysis means for acquiring a detection result of an abnormality with respect to a log using a model in which a normal operation has been learned based on a past normal log. The analysis unit 102 inputs the log acquired by the acquisition unit 101 to the machine learning model in which the normal operation has been learned. Then, the analysis unit 102 acquires the detection result of the abnormality with respect to the log from the model as the output of the model. The analysis unit 102 acquires a detection result of an abnormality related to at least one of a command pattern, a variable related to login, a frequency of login, and a frequency of command input. The detection result of the abnormality will be described in detail later.

The analysis unit 102 uses a machine learning model in which a normal operation has been learned. Therefore, first, model learning will be described. The abnormality detection device 10 may include a learning unit 106 and a model management unit 107.

The learning unit 106 is one aspect of a learning means for learning a normal operation based on a past normal log for a model. The model management unit 107 is one aspect of a model management means for managing a learned model. That is, the model management unit 107 includes a learned model. The learning unit 106 performs learning on the model included in the model management unit 107.

The learning unit 106 learns the model using the past normal log as learning data. The past normal log is a log obtained by removing a log in which an abnormality has occurred from the accumulated past log. The occurrence of the log abnormality may be determined by, for example, a monitoring person of the network device 90. For example, occurrence of abnormality in the log may be determined by feedback from the monitoring person of the network device 90 to the detection result acquired by the analysis unit 102. The learning unit 106 may iteratively learn the model by feeding back the log in which the occurrence of the abnormality is detected in the detection result.

The learning unit 106 learns a normal operation for the model. Here, the normal operation is a login operation in which no abnormality is detected and input of a command in which no abnormality is detected. The learning unit 106 learns each of the command pattern, the variable related to login, and the frequency of the operation as the abnormality detection method. The abnormality detection method is an analysis item for detecting an abnormality of a log. One model or a plurality of models may be learned. For example, the model may be different for each detection method. In the following description of the abnormality detection method, it is assumed that the login history illustrated as an example in FIG. 2 and the command history illustrated as an example in FIG. 3 are examples of the normal login history and the command history.

The command pattern is a pattern of a command input to the network device 90. In a case where the detection method is the command pattern, the learning unit 106 learns the command pattern by using a normal command history included in a normal log as learning data. The learning unit 106 extracts a command pattern from the command history illustrated as an example in FIG. 3. Specifically, the learning unit 106 detects a portion that changes over a plurality of rows and a portion that does not change over a plurality of rows in the command history. Then, in a case where a portion changing over a plurality of rows is removed, the learning unit 106 extracts a common command pattern. The learning unit 106 can learn the extracted command pattern as a normal command pattern.

The variable related to login is a variable used for login to the network device 90. In a case where the detection method is a variable related to login, the learning unit 106 learns the variable related to login using a normal login history included in a normal log as learning data. The variable related to login is information obtained by excluding the login time from the information regarding login included in the login history. In the login history illustrated in FIG. 2 as an example, variables related to login include a device number, a login result, a login failure reason, a user name, and an access source. The learning unit 106 records a value for each variable related to login in the login history. In an example of the login history of FIG. 2, the learning unit 106 stores values of 15 and 3 for the device numbers which are variables related to login. The learning unit 106 also stores a value for the user name that is a variable related to login. Furthermore, the learning unit 106 also learns the value of the IP address of the access source, which is a variable related to login. The learning unit 106 learns the value of each variable related to login as a normal value.

The frequency of operation is a frequency of login to the network device 90 and a frequency of command input to the network device 90. In a case where the detection method is the frequency of login, the learning unit 106 learns the frequency of login using the normal login history included in the normal log as learning data. In a case where the detection method is the frequency of command input, the learning unit 106 learns the frequency of command input using a normal command history included in a normal log as learning data.

The learning of the frequency of the operation will be described using the frequency of login as an example. The learning unit 106 extracts a login pattern from the login history illustrated as an example in FIG. 2. The login pattern can be extracted from the login history by a method similar to the above-described command pattern extraction method. The learning unit 106 divides the login history in a predetermined time width with respect to the login history illustrated in an example in FIG. 2. The predetermined time width can be set to any time width by a monitoring person of the network device 90, for example. Here, a case where the login history is divided into five of A, B, C, D, and E will be described as an example. For each divided login history, the number of appearances of the extracted login pattern is counted. For example, in the divided login history A, the login pattern a is extracted three times, and the login pattern b is extracted once. It is assumed that login pattern a appears five times in login history B, twice in login history C, seven times in login history D, and four times in login history E. An upper limit and a lower limit of the number of appearances in a predetermined time width are obtained for each login pattern. For the login pattern a, the upper limit can be obtained as seven times, and the lower limit can be obtained as two times. The learning unit 106 learns the upper limit and the lower limit of the number of appearances as the frequency of normal login as the range of the number of appearances of the login pattern. The frequency of command input can also be learned by a similar method.

The normal operation learning method is not limited thereto.

The analysis unit 102 acquires the detection result of the abnormality with respect to the log using the machine learning model in which the normal operation is learned. The analysis unit 102 inputs a log to the learned model in which the normal operation has been learned. The input log is a log of an abnormality detection target acquired by the acquisition unit 101. As described above, the acquisition unit 101 can acquire, for example, a login history and a command history for one day as a log of an abnormality detection target. At this time, the analysis unit 102 can input a login history and a command history for one day to the learned model.

The analysis unit 102 acquires the detection result of the abnormality with respect to the log from the learned model as the output of the learned model. The analysis unit 102 acquires a detection result of an abnormality related to at least one detection method among a command pattern, a variable related to login, and a frequency of operation. As described above, the abnormality detection method is an analysis item for detecting an abnormality in the log. Therefore, the analysis unit 102 acquires the detection result of the abnormality related to at least one analysis item output by the learning model. In the following description of the detection result of the abnormality, it is assumed that the login history illustrated as an example in FIG. 2 and the command history illustrated as an example in FIG. 3 are examples of the login history and the command history of the detection target.

In a case where the detection method is the command pattern, the analysis unit 102 inputs the command history included in the log of the detection target to the model. Then, it is determined whether each row of the command history matches any of the learned command patterns. Then, in a case where a row that does not match any learned pattern is detected, mismatch of the rows is detected. That is, an abnormality with respect to the command history is detected. Then, the model outputs information of the row in which the mismatch is detected as the detection result. The analysis unit 102 acquires the detection result of the abnormality including the information of the row in which the mismatch is detected. In the example of FIG. 3, the information of the row in which the mismatch is detected includes the command input time, the device number, and the command character string.

On the other hand, in a case where a row that does not match any learned pattern is not detected, an abnormality with respect to the command history is not detected. That is, it is detected that there is no abnormality in the command history. Therefore, in a case where the detection method is the command pattern, the analysis unit 102 may acquire the detection result indicating that there is no abnormality.

In a case where the detection method is a variable related to login, the analysis unit 102 inputs a login history included in the log to be detected to the model. Then, a login pattern is extracted for the login history according to the model. The model further extracts a value for each variable related to login in each extracted pattern. It is determined by the model whether each value extracted for each variable related to login is included in the value stored for the variable related to login. Then, in a case where the extracted value is not included in the stored value, the model detects a mismatch between the values. That is, the model detects an abnormality in the login history. Then, the model outputs, as the detection result, information indicating the variable related to the login in which the mismatch is detected and a value of the variable related to the login. The information indicating the variable related to login is, for example, a name of the variable related to login. That is, the detection result indicates which variable is the variable related to the login in which the mismatch is detected and the value of the variable. The analysis unit 102 acquires the information indicating the variable related to the login in which the mismatch is detected and the detection result of the abnormality including the value of the variable related to the login.

On the other hand, in a case where a variable of which the extracted value is not included in the learned value is not detected, no abnormality with respect to the login history is detected. That is, it is detected that there is no abnormality in the login history. Therefore, the analysis unit 102 may acquire a detection result indicating that there is no abnormality in a case where the detection method is a variable related to login.

In a case where the detection method is the frequency of operation, the frequency of login will be described as an example. The analysis unit 102 inputs the login history included in the log to be detected to the model. Then, a login pattern is extracted in the login history according to the model. The login history is divided by a predetermined time width according to the model. The predetermined time width can be set to any time width by a monitoring person of the network device 90, for example. Then, in the divided login history, the number of appearances of each login pattern is counted by the model. For each of the divided login histories, whether the number of appearances for each login pattern is included in the range of the learned number of appearances is determined by the model. In a case where a login pattern in which the number of appearances is not included in the range of the learned number of appearances is detected in a certain login history, the model detects an abnormality with respect to the login history. Then, the model acquires, as the detection result, the detection result of the abnormality including the login pattern not included in the range of the number of appearances and the time section of the login history in which the login pattern is detected. The analysis unit 102 acquires the detection result of the abnormality including the login pattern not included in the range of the number of appearances and the time section of the login history in which the login pattern is detected.

On the other hand, in a case where the login pattern of which the number of appearances is not included in the range of the learned number of appearances is not detected, no abnormality with respect to the login history is detected. The case where the login pattern not included in the learned range of the number of appearances is not detected is a case where the number of appearances of any login pattern is included in the range of the number of appearances in all the divided login histories. At this time, it is detected that there is no abnormality in the login history. Therefore, the analysis unit 102 may acquire a detection result indicating that there is no abnormality in a case where the detection method is a variable related to login.

Even in a case where the detection method is the frequency of command input, the abnormality can be detected by a method similar to the case of the frequency of login.

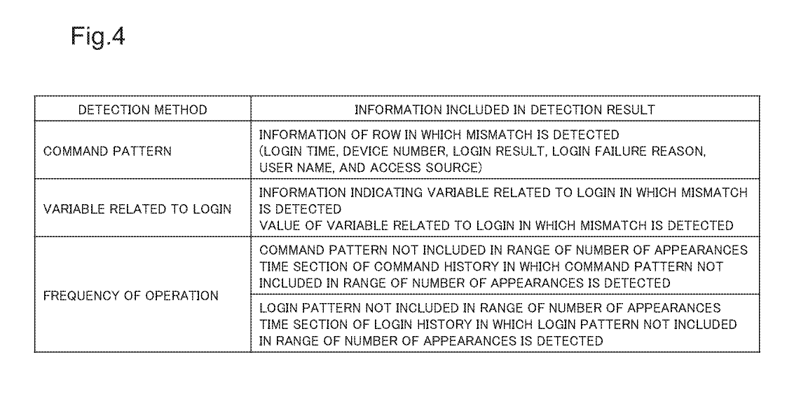

FIG. 4 is a diagram illustrating an example of an abnormality detection method and information included in a detection result in a case where an abnormality is detected in each detection method. The detection result includes information according to the detection method in which the abnormality is detected. The analysis unit 102 can acquire a detection result of the abnormality according to the detection method in which the abnormality is detected. Referring to FIG. 4, in a case where the abnormality detection method is the command pattern, the detection result includes information of the row in which the mismatch is detected. The example illustrated in FIG. 3 includes a command input time, a device number, and a command character string, but is not limited thereto. In a case where the abnormality detection method is a variable related to login, the detection result includes information indicating the variable related to login in which mismatch is detected and a value of the variable related to login. In a case where the abnormality detection method is the frequency of the operation, the detection result includes the login pattern not included in the range of the number of appearances and the time section of the login history in which the login pattern is detected. The detection result includes a command pattern not included in the range of the number of appearances and a time section of a command history in which the command pattern is detected. The information included in the detection result is an example, and is not limited thereto.

The analysis unit 102 may acquire the abnormality detection method for all the detection methods among the plurality of detection methods. The analysis unit 102 may acquire the detection result of the abnormality in some of the plurality of detection methods. In a case where the model is different for each detection method, the analysis unit 102 may acquire the detection result of the abnormality using the model of the detection method selected according to the log. For the login history included in the log, the analysis unit 102 may acquire the detection result of the abnormality for the detection method in which the detection target is the login history. That is, the analysis unit 102 can select the model of the detection method in which the detection target is the login history, and acquire the detection result of the abnormality. For the command history included in the log, the analysis unit 102 may acquire the detection result of the abnormality for the detection method in which the detection target is the command history. That is, the analysis unit 102 can select the model of the detection method in which the detection target is the command history, and acquire the detection result of the abnormality. In a case where an abnormality is detected in a plurality of detection methods, the analysis unit 102 can acquire a detection result of the abnormality including information according to each detection method. In a case where no abnormality is detected in any of the detection methods, the analysis unit 102 can acquire a detection result indicating that no abnormality is detected.

Here, the learning unit 106 and the model management unit 107 may be included in an information processing device different from the abnormality detection device 10. In this case, the analysis unit 102 transmits the log to the information processing device including the model management unit 107. Then, the analysis unit 102 can acquire the detection result of the abnormality from the information processing device.

The analysis unit 102 may acquire the detection result of the abnormality by collation using a data set related to normal operation. That is, the model in which the normal operation has been learned based on the past normal log may be a data set related to the normal operation. The data set related to the normal operation includes the normal command pattern, the normal value of each variable related to login, the upper limit and the lower limit of the number of appearances for each login pattern, and the upper limit and the lower limit of the number of appearances for each command pattern. The analysis unit 102 collates the acquired log with the data set. Then, the analysis unit 102 can acquire the detection result of the abnormality as the collation result.

The identification unit 103 is one aspect of a identification means for identifying the meaning indicated by the abnormality for the login related to the abnormality based on the detection result and the login history. As described above, the analysis unit 102 acquires the detection result of the abnormality with respect to the log by using the machine learning model in which the normal operation is learned. In a case where an abnormality is detected in the log, for example, the monitoring person of the network device 90 may want to know the meaning of the abnormality. Therefore, in a case where an abnormality is detected, the identification unit 103 identifies the meaning indicated by the abnormality. The identification unit 103 identifies login related to the detected abnormality. Here, the meaning indicated by the abnormality includes input of a command different from usual, login using a value different from usual, command input at a frequency different from usual, frequent login attempts, and suspected monitoring interference. The meaning indicated by the abnormality may be a reason for the abnormality, a cause of the abnormality, or details of the abnormality. The meaning indicated by the abnormality will be described in detail later.

The identification unit 103 includes a meaning identification unit 1031 and a history identification unit 1032.

The meaning identification unit 1031 is one aspect of a meaning identification means for identifying a meaning indicated by an abnormality associated with a classification condition satisfied by a log, for the classification condition for classifying an abnormality. In a case where an abnormality is detected in the log in the detection result, the meaning identification unit 1031 acquires the log. The log may be included in the detection result acquired from the analysis unit 102. The meaning identification unit 1031 may acquire a log from the acquisition unit 101. Further, the meaning identification unit 1031 acquires a detection result from the analysis unit 102. The meaning identification unit 1031 identifies the meaning indicated by the detected abnormality using the log and the classification condition for classifying the detected abnormality.

The detection result includes a detection method in which an abnormality is detected. The classification condition is set in advance for each detection method. Therefore, the meaning identification unit 1031 uses a classification condition according to the detection method included in the detection result. The classification condition is associated with meaning information. The meaning information is information indicating the meaning indicated by the abnormality. Therefore, in a case where the log satisfies any of the classification conditions, the meaning identification unit 1031 can identify the meaning information associated with the classification condition as the meaning indicated by the detected abnormality. In this manner, the meaning of the detected abnormality is identified by the meaning identification unit 1031.

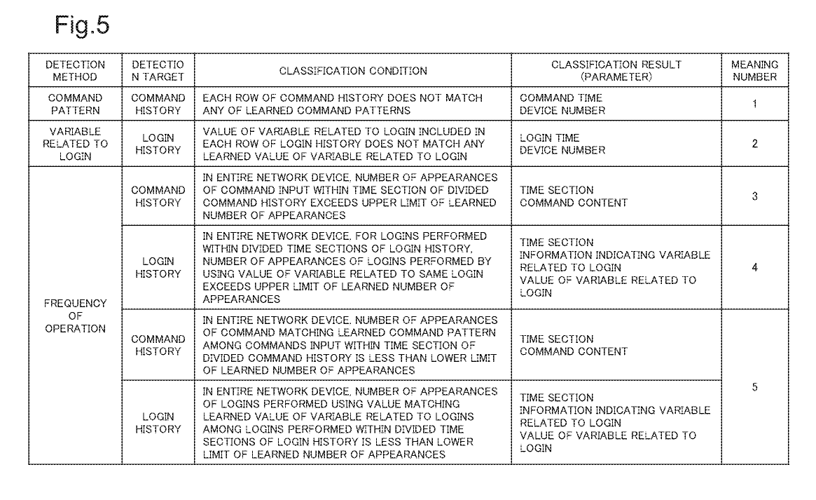

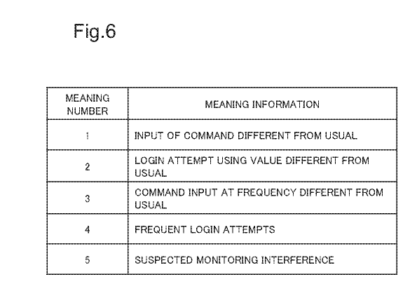

The classification condition according to the detection method and the meaning indicated by the abnormality will be described. The classification condition according to the detection method and the meaning indicated by the abnormality will be described with reference to FIGS. 5 and 6. FIG. 5 is a diagram illustrating an example of a classification condition, a detection target, and a classification result according to a detection method. FIG. 6 is a diagram illustrating an example of meaning numbers and meaning information.

FIG. 5 illustrates detection targets to which the classification conditions are applied. In the example illustrated in FIG. 5, each classification condition is associated with a meaning number. The meaning number is a number used by the meaning identification unit 1031 to identify the meaning indicated by the abnormality. In a case where the log to be detected satisfies the classification condition, the meaning identification unit 1031 identifies the meaning number associated with the classification condition.

In the diagram illustrated in FIG. 6, the meaning number and the meaning indicated by the abnormality are associated with each other. The meaning identification unit 1031 can identify the meaning indicated by the abnormality associated with the identified meaning number. That is, in a case where an abnormality is detected in the log, the meaning identification unit 1031 can identify the meaning information associated with the classification condition satisfied by the log as the meaning indicated by the abnormality. The method for identifying the meaning indicated by the abnormality is an example, and the meaning number may not be used.

The meaning identification unit 1031 further narrows down the parameters from the log to be detected using the classification condition. As described above, the log includes a plurality of parameters. Therefore, the meaning identification unit 1031 narrows down the parameters related to the classification condition from the plurality of parameters included in the log. That is, the narrowed parameter is a parameter related to the classification condition among the parameters included in the log. The narrowed parameter is referred to as a classification result. The classification result may include a meaning number.

First, a case where the detection method in which the abnormality is detected is the command pattern will be described. In a case where the detection method is the command pattern, the detection target in the meaning identification unit 1031 is the command history. The classification condition is that each row of the command history does not match any of the learned command patterns. In a case where the command history satisfies the above classification condition, the meaning identification unit 1031 identifies the meaning number as 1. Then, referring to FIG. 6, meaning information “input of a command different from usual” is associated with the meaning number 1. That is, the meaning identification unit 1031 can identify the meaning of “input of a command different from usual” as the meaning indicated by the abnormality. Since the command history does not match any of the learned command patterns, there is a possibility that a command different from usual is input. Therefore, the meaning identification unit 1031 can identify the meaning indicating the possibility that a command different from usual is input as the meaning indicated by the abnormality. The expression of the meaning indicated by the abnormality is not limited to “input of a command different from usual”. For example, the expression of the meaning indicated by the abnormality may be an expression of “a command that has not been input before”.

Here, in a case where the detection method is the command pattern, the abnormality detection method by the model and the classification condition have similar contents. In the model, an abnormality is detected in a case where a row that does not match any learned pattern is detected among the rows of the command history. That is, in a case where the detection method is the command pattern, the meaning identification unit 1031 can identify that the meaning indicated by the abnormality is “input of a command different from usual”. In a case where the detection method is the command pattern, the classification condition may not be used.

The meaning identification unit 1031 further narrows down the parameters as the classification result from the command history of the detection target using the classification condition. The parameters narrowed down by the classification condition are the command time and the device number in the row of the command history that does not match any of the learned command patterns. That is, the meaning identification unit 1031 can output the classification result including the command time and the device number of the row in which the mismatch is detected.

Next, a case where the detection method in which the abnormality is detected is a variable related to login will be described. In a case where the detection method is a variable related to login, the detection target in the meaning identification unit 1031 is a login history. The classification condition is that the value of the variable related to the login included in each row of the login history does not match any learned value of the variable related to the login. In a case where the login history satisfies the classification condition, the meaning identification unit 1031 identifies the meaning number as 2. Then, referring to FIG. 6, meaning information “login attempt using a value different from usual” is associated with meaning number 2. That is, the meaning identification unit 1031 can identify the meaning of “login attempt using a value different from usual” as the meaning indicated by the abnormality. Since the value of the variable related to login included in each row of the login history does not match any of the learned values of the variables related to login, for example, there is a possibility that login is attempted using a variable value different from usual. Therefore, the meaning identification unit 1031 can identify, as the meaning indicated by the abnormality, the meaning indicating the possibility that login has been attempted using the value of the variable different from usual. Here, the login attempt includes a case where the login result is successful and a case where the login result is a failure for the login attempted by the user. The expression of the meaning indicated by the abnormality is not limited to “login attempt using a value different from usual”. The expression of the meaning indicated by the abnormality may be, for example, an expression indicating a variable related to login that is a value different from the learned value. A identified example of expression of the meaning indicated by the abnormality may be “login attempt using a user name different from usual”.

Here, in a case where the detection method is a variable related to login, the abnormality detection method by the model and the classification condition have similar contents. In the model, in a case where the value of the variable related to login is not included in the stored value of the variable related to login, an abnormality is detected. That is, in a case where the detection method is a variable related to login, the meaning identification unit 1031 can identify that the meaning indicated by the abnormality is “login attempt using a value different from usual”. In a case where the detection method is a variable related to login, the classification condition may not be used.

The meaning identification unit 1031 further narrows down the parameters as the classification result from the login history of the detection target using the classification condition. The parameters narrowed down by the classification condition are the login time and the device number in the row including the variable that does not match any of the learned values. That is, the meaning identification unit 1031 can output the classification result including the login time and the device number of the row in which the mismatch of the values is detected.

A case where the detection method in which the abnormality is detected is the frequency of the operation will be described. In a case where the detection method is the frequency of the operation, there are a plurality of classification conditions. Therefore, the meaning identification unit 1031 can identify the meaning information associated with the classification condition satisfied by the log to be detected as the meaning indicated by the abnormality.

One of the classification conditions in a case where the detection method is the frequency of operation is that the number of appearances of the command pattern exceeds the upper limit of the learned number of appearances in all the network devices 90. The detection target is command histories of all the network devices 90 monitored by the abnormality detection device 10. The meaning identification unit 1031 extracts command patterns for the command histories of all the network devices 90 monitored by the abnormality detection device 10. The meaning identification unit 1031 divides the command history by a predetermined time width. Then, in the divided command history, the number of appearances of the command pattern is counted for each command pattern. Then, the meaning identification unit 1031 determines whether the number of appearances counted for each command pattern exceeds the upper limit of the learned number of appearances. Then, the meaning identification unit 1031 can determine that the above-described classification condition is satisfied in a case where the counted number of appearances exceeds the upper limit of the learned number of appearances. At this time, the meaning identification unit 1031 can identify the meaning number as 3 in the example illustrated in FIG. 5. Then, referring to FIG. 6, meaning information “command input at a frequency different from usual” is associated with meaning number 3. That is, the meaning identification unit 1031 can identify the meaning of “command input at a frequency different from usual” as the meaning indicated by the abnormality. In a case where the number of appearances of the command pattern input within the time section exceeds the upper limit of the learned number of appearances, there is a possibility that the command is input at a frequency different from the normal frequency. That is, there is a possibility that the command is input at a higher frequency than usual. Therefore, the meaning identification unit 1031 can identify the meaning indicating the possibility that the command is input at a higher frequency than usual as the meaning indicated by the abnormality. The expression of the meaning indicated by the abnormality is not limited to “command input at a frequency different from usual”. The expression of the meaning indicated by the abnormality may be, for example, “command input at a higher frequency than usual”.

The meaning identification unit 1031 further narrows down the parameters as the classification result from the command history of the detection target using the classification condition. Parameters narrowed down by the classification condition are a time section and command contents. The time section included in the parameter is a time section in which a command pattern exceeding the upper limit of the learned number of appearances is input. The command content is the command content of the command pattern input the number of times exceeding the upper limit of the learned number of appearances. The command content is, for example, a command character string. That is, the meaning identification unit 1031 can output the classification result including the command content of the number of appearances exceeding the upper limit of the learned number of appearances and the time section in which the command is input.

The classification condition in a case where the detection method is the frequency of operation is that, for logins performed within the time

section of the divided login histories in all the network devices 90, the number of appearances of logins performed using the value of the variable related to the same login exceeds the upper limit of the learned number of appearances. The detection target is login histories of all the network devices 90 monitored by the abnormality detection device 10. The meaning identification unit 1031 counts the number of appearances of logins performed using the value of the variable related to the same login for logins performed within the time section of the divided login history among the login histories of all the network devices 90 monitored by the abnormality detection device 10 for each variable related to the logins. Then, the meaning identification unit 1031 determines whether the counted number of appearances exceeds the upper limit of the learned number of appearances. Then, the meaning identification unit 1031 can determine that the above-described classification condition is satisfied in a case where the counted number of appearances exceeds the upper limit of the learned number of appearances. At this time, the meaning identification unit 1031 can identify the meaning number as 4 in the example illustrated in FIG. 5. Referring to FIG. 6, meaning information “frequent login attempts” is associated with meaning number 4. That is, the meaning identification unit 1031 can identify the meaning of “frequent login attempts” as the meaning indicated by the abnormality. In a case where the number of appearances of logins in which the value of the variable related to the same login is used exceeds the upper limit of the learned number of appearances within the time section, there is a possibility that the login is attempted at a frequency different from the normal frequency. That is, there is a possibility that login is frequently attempted. Therefore, the meaning identification unit 1031 can identify the meaning indicating the possibility of frequent login attempts as the meaning indicated by the abnormality. The expression of the meaning indicated by the abnormality is not limited to “frequent login attempts”. The expression

of the meaning indicated by the abnormality may be, for example, “login attempts at a higher frequency than usual”.

The meaning identification unit 1031 further narrows down the parameters as the classification result from the login history of the detection target using the classification condition. Parameters narrowed down by the classification condition are a time section, information indicating a variable related to login, and a value of the variable. The time section included in the parameter is a time section in which login is attempted more than the upper limit of the learned number of appearances. The information indicating the variable related to login included in the parameter and the value of the variable are information indicating the variable related to login and the value of the variable used for login exceeding the upper limit of the learned number of appearances. The meaning identification unit 1031 can output a time section and a classification result including information indicating a variable related to login and a value of the variable.

The classification condition in a case where the detection method is the frequency of operation is that, in all the network devices 90, the number of appearances of a command matching the learned command pattern or the number of appearances of logins performed using a value matching the learned value of the variable related to the logins is less than the lower limit of the learned number of appearances. The detection target is a login history or a command history included in all the logs of the network device 90 monitored by the abnormality detection device 10. The meaning identification unit 1031 can determine that the above classification condition is satisfied in a case where the number of appearances counted for each command pattern is less than a lower limit of the learned number of appearances. The meaning identification unit 1031 can determine that the above-described classification condition is satisfied in a case where the number of appearances counted for each variable related to login is less than the lower limit of the learned number of appearances. In a case where the log to be detected satisfies the above classification condition, the meaning identification unit 1031 can identify the meaning number as 5 in the example illustrated in FIG. 5. Referring to FIG. 6, meaning information “suspected monitoring interference” is associated with meaning number 5. That is, the meaning identification unit 1031 can identify the meaning of “suspected monitoring interference” as the meaning indicated by the abnormality. Here, the expression of the meaning indicated by the abnormality is not limited to “suspected monitoring interference”. The expression of the meaning indicated by the abnormality may be, for example, “suspected of erasing logs or interrupting log collection”.

The classification condition and the detection target in the case of being identified as “suspected monitoring interference” will be described in more detail. In a case where the detection target is the command history, the classification condition is that, in all the network devices 90, the number of appearances of a command matching the learned command pattern among the commands input within the time section of the divided command history is less than the lower limit of the learned number of appearances. For all the command histories of the network device 90 monitored by the abnormality detection device 10, the meaning identification unit 1031 counts the number of appearances of commands matching the learned command pattern among the commands input within the time section of the divided command history. Then, it is determined whether the counted number of appearances is below the lower limit of the learned number of appearances. Then, the meaning identification unit 1031 can determine that the above-described classification condition is satisfied in a case where the counted number of appearances is below the lower limit of the learned number of appearances. That is, the meaning identification unit 1031 can identify the meaning of “suspected monitoring interference” as the meaning indicated by the abnormality. In a case where the number of appearances of the command matching the command pattern is less than the lower limit of the learned number of appearances, there is a possibility that monitoring is interrupted, for example, logs are erased or log collection is interrupted. Therefore, the meaning identification unit 1031 can identify the meaning indicating the possibility that the monitoring has been interrupted as the meaning indicated by the abnormality.

The meaning identification unit 1031 further narrows down the parameters as the classification result from the log to be detected using the classification condition. The meaning identification unit 1031 narrows down the time section and the command content from the command history of the detection target using the classification condition. The time section included in the classification result is a time section in which the number of appearances of the command matching the learned command pattern is less than the lower limit of the learned number of appearances. The command content included in the classification result is the command content of the command which is the number of appearances falling below the lower limit of the learned number of appearances. The command content is, for example, a command character string. The meaning identification unit 1031 can output the classification result including the time section and the command content.

In a case where the detection target is the login history, the classification condition is that, in all the network devices 90, the number of appearances of logins performed using a value that matches the learned value of the variable related to the login among logins performed within the time section of the divided login history is less than the lower limit of the learned number of appearances. For all the login histories of the network device 90 monitored by the abnormality detection device 10, the meaning identification unit 1031 counts the number of appearances of logins performed using a value matching the learned value of the variable related to the login among logins performed within the time section of the divided login history. Then, it is determined whether the counted number of appearances is below the lower limit of the learned number of appearances. Then, the meaning identification unit 1031 can determine that the above-described classification condition is satisfied in a case where the counted number of appearances is below the lower limit of the learned number of appearances. That is, the meaning identification unit 1031 can identify the meaning of “suspected monitoring interference” as the meaning indicated by the abnormality. Even in a case where the number of appearances of logins performed using the learned value of the variable related to the logins is less than the lower limit of the learned number of appearances, there is a possibility that monitoring is interrupted, for example, logs are erased or log collection is interrupted. Therefore, the meaning identification unit 1031 can identify the meaning indicating the possibility that the monitoring has been interrupted as the meaning indicated by the abnormality.

The meaning identification unit 1031 further narrows down the parameters as the classification result from the log to be detected using the classification condition. The meaning identification unit 1031 narrows down the time section, the information indicating the variable related to the login, and the value of the variable from the login history of the detection target using the classification condition. The time section included in the classification result is a time section in which the number of appearances of logins performed using the learned value of the variable related to the logins is less than the lower limit of the learned number of appearances. The information indicating the variable related to the login included in the classification result is information indicating the variable related to the login used for the login in which the number of appearances is less than the lower limit of the learned number of appearances. The value of the variable related to login is the value of the variable related to login used for login in which the number of appearances is less than the lower limit of the learned number of appearances. The meaning identification unit 1031 can output a classification result including a time section, information indicating a variable related to login, and a value of the variable.

The meaning identification unit 1031 identifies the meaning indicated by the abnormality using the classification condition. The meaning identification unit 1031 outputs a parameter narrowed down by the classification condition as a classification result. The classification result is used for search of a login history in the history identification unit 1032 described below.

The history identification unit 1032 is one aspect of a history identification means for using a parameter narrowed down by a classification condition satisfied by a log to search a login related to an abnormality from a login history. As described above, the meaning identification unit 1031 outputs the parameters narrowed down by the classification condition as the classification result. Therefore, the history identification unit 1032 uses the parameter output from the meaning identification unit 1031 to search the login history for the login related to the abnormality. The login related to the abnormality differs depending on the meaning indicated by the abnormality. That is, the login related to the abnormality, which is the search target, differs depending on the meaning indicated by the abnormality. The login related to the abnormality, which is the search target, is set in advance for each meaning indicated by the abnormality. A parameter that is a classification result is used as a search condition when searching for a search target.

The history identification unit 1032 searches for the login related to the abnormality, which is the search target, from the login history using the parameter. Since the search target is set for each meaning indicated by the abnormality, when the meaning identification unit 1031 identifies the meaning indicated by the abnormality, the history identification unit 1032 can search the login history for the search target related to the meaning indicated by the abnormality. Since the meaning indicated by the abnormality is associated with the classification condition, in a case where the log satisfies a certain classification condition, the history identification unit 1032 searches the login history for the search target associated with the classification condition.

The history identification unit 1032 uses the parameter output from the meaning identification unit 1031 to search for a search target according to the meaning indicated by the abnormality. By the search, the login related to the abnormality, which is the search target, is extracted. Then, the history identification unit 1032 outputs the login history from which the login related to the abnormality is extracted as a search result. The login history from which the login related to the abnormality is extracted is referred to as a identified login list. The identified login list includes information regarding logins of the extracted logins. The identified login list includes the meaning indicated by the abnormality. That is, the identified login list includes the meaning of the abnormality related to the login included in the identified login list.

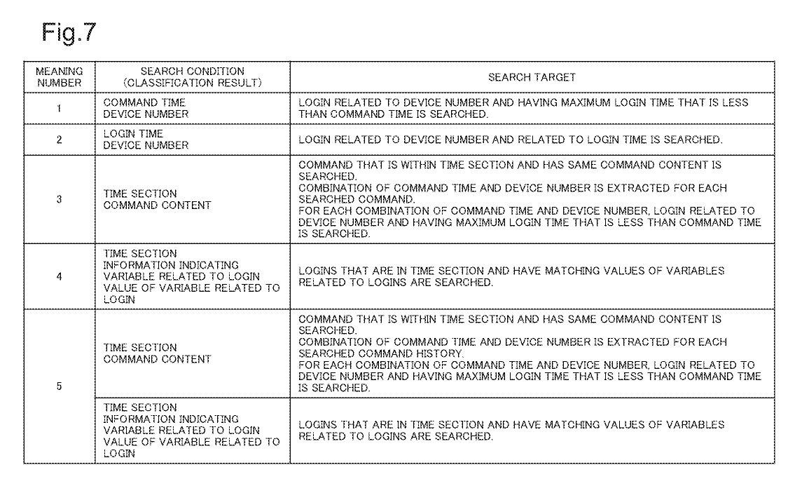

The search target according to the meaning indicated by the abnormality will be described with reference to FIG. 7. FIG. 7 is a diagram illustrating an example of the search condition and the search target according to the meaning indicated by the abnormality. In FIG. 7, the search condition and the search target are illustrated for each meaning number used in FIGS. 5 and 6.

A case where the meaning number is 1 will be described. At this time, the search condition that is the classification result output by the meaning identification unit 1031 is the command time and the device number. Therefore, the history identification unit 1032 searches for the login in which the device number related to the device number of the search condition and the login time is the maximum that is less than the command time in the login history. Then, the history identification unit 1032 outputs a identified login list including information regarding logins extracted by the search. In a case where there is no login related to the search target, the history identification unit 1032 may output information indicating that there is no related login.

A case where the meaning number is 2 will be described. At this time, the search condition that is the classification result output by the meaning identification unit 1031 is the login time and the device number. Therefore, the history identification unit 1032 searches for login in which the device number is related to the device number of the search condition and the login time is the login time of the search condition in the login history. Then, the history identification unit 1032 outputs a identified login list including information regarding logins extracted by the search. In a case where there is no login related to the search target, the history identification unit 1032 may output information indicating that there is no related login.

A case where the meaning number is 3 will be described. At this time, the search condition that is the classification result output by the meaning identification unit 1031 is the time section and the command content. Therefore, the history identification unit 1032 first searches for a command whose command time is within the time section and whose command content matches the command content of the search condition in the command history. Then, the meaning identification unit 1031 extracts a combination of the command time and the device number for each command extracted by the search. For the combination of the command time and the device number in the login history, the meaning identification unit 1031 searches for the login in which the device number is related to the device number included in the combination and the login time is the maximum that is less than the command time. Then, the history identification unit 1032 outputs a identified login list including information regarding logins extracted by the search. At this time, the number of logins included in the identified login list may be plural. For example, the number of logins included in the identified login list may be the same as the number of combinations of the command time and the device number.

A case where the meaning number is 4 will be described. At this time, the search condition that is the classification result output by the meaning identification unit 1031 is the time section, the information indicating the variable related to login, and the value of the variable. Therefore, the history identification unit 1032 searches for logins in which the login time is within the time section and the values of the variables related to the logins match in the login history. Then, the history identification unit 1032 outputs a identified login list including information regarding logins extracted by the search. At this time, the number of logins included in the identified login list may be plural.

A case where the meaning number is 5 will be described. First, a case where the search condition that is the classification result output by the meaning identification unit 1031 is the time section and the command content will be described. The history identification unit 1032 first searches the command history for a command whose command time is within the time section and whose command content matches the command content of the search condition. Then, the meaning identification unit 1031 extracts a combination of the command time and the device number for each command extracted by the search. For the combination of the command time and the device number in the login history, the meaning identification unit 1031 searches for the login in which the device number is related to the device number included in the combination and the login time is the maximum that is less than the command time. Then, the history identification unit 1032 outputs a identified login list including information regarding logins extracted by the search. At this time, the number of logins included in the identified login list may be plural. For example, the number of logins included in the identified login list may be the same as the number of combinations of the command time and the device number.

Next, a case where the meaning number is 5 and the search condition that is the classification result output by the meaning identification unit 1031 is the time section, the information indicating the variable related to login, and the value of the variable will be described. The history identification unit 1032 searches for logins in which the login time is within the time section and the values of the variables related to the logins match in the login history. Then, the history identification unit 1032 outputs a identified login list including information regarding logins extracted by the search. At this time, the number of logins included in the identified login list may be plural.

The output unit 104 is one aspect of an output means for outputting the login related to the abnormality and the meaning indicated by the abnormality in association with each other. The output unit 104 outputs the login related to the abnormality identified by the history identification unit 1032 and the meaning indicated by the abnormality identified by the meaning identification unit 1031 in association with each other. For example, in a case where the abnormality detection device 10 has a display function, the output unit 104 can display the login related to the abnormality and the meaning indicated by the abnormality in association with each other. In a case where the abnormality detection device 10 is connected to a display device (not illustrated) such as a display, the output unit 104 may output the login related to the abnormality and the meaning indicated by the abnormality in association with each other to the display device. That is, the output unit 104 outputs the identified login list which is the search result in the history identification unit 1032. That is, the output unit 104 transmits the identified login list to the display device. The display device receives the identified login list. Then, the display device can display the login related to the abnormality and the meaning indicated by the abnormality in association with each other on the screen.

The output destination by the output unit 104 is not limited thereto. In addition, the output unit 104 may output the login related to the abnormality and the meaning indicated by the abnormality in association with each other to an information processing device different from the abnormality detection device 10. That is, the output unit 104 can transmit the identified login list to the information processing device. The information processing device is, for example, a device managed by a monitoring person of the network device 90. By transmitting the identified login list to the device managed by the monitoring person of the network device 90, the monitoring person can confirm the login related to the abnormality and the meaning of the abnormality.

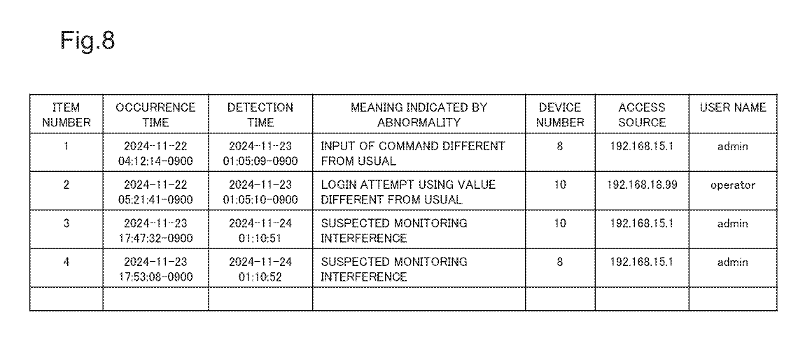

An example of a screen on which the login related to the abnormality and the meaning indicated by the abnormality are displayed in association with each other will be described with reference to FIG. 8. FIG. 8 is a diagram illustrating an example of a screen on which a login related to an abnormality and a meaning indicated by the abnormality are displayed. In the example illustrated in FIG. 8, four logins related to abnormality are displayed. For each login, the occurrence time, the detection time, the meaning indicated by the abnormality, the device number, the access source, and the user name are displayed. The occurrence time is a login time. The detection time may be, for example, a time when the meaning indicated by the abnormality is identified by the meaning identification unit 1031, or may be a time when the acquisition unit 101 has acquired the log. Since the meaning indicated by the abnormality is displayed in the same row for each login, the login related to the abnormality and the meaning indicated by the abnormality are displayed in association with each other. The information displayed for the login related to the abnormality is not limited thereto.

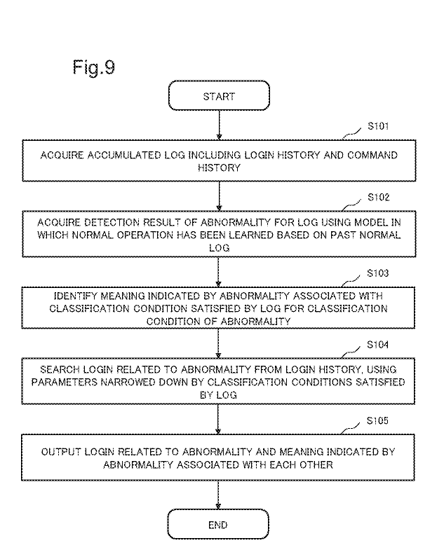

The operation of the abnormality detection device 10 including the acquisition unit 101, the analysis unit 102, the meaning identification unit 1031, the history identification unit 1032, and the output unit 104 will be described with reference to FIG. 9. FIG. 9 is a first flowchart illustrating an example of the operation of the abnormality detection device.

In step S101, the acquisition unit 101 acquires a log including the accumulated login history and command history. In step S102, the analysis unit 102 acquires the detection result of the abnormality with respect to the log using the model in which the normal operation has been learned based on the past normal log. In step S103, the meaning identification unit 1031 identifies the meaning indicated by the abnormality associated with the classification condition satisfied by the log for the classification condition for classifying the abnormality. In step S104, the history identification unit 1032 searches the login history for the login related to the abnormality by using the parameters narrowed down by the classification condition satisfied by the log. In step S105, the output unit 104 outputs the login related to the abnormality and the meaning indicated by the abnormality in association with each other. Then, the abnormality detection device 10 ends the operation. Here, in step S102, the analysis unit 102 can acquire an abnormality detection result for a plurality of detection methods. The abnormality detection device 10 may repeat the processing of the flowchart exemplified in FIG. 9 for each of the plurality of detection methods.

In the abnormality detection device 10 according to the present example embodiment, the analysis unit 102 acquires the detection result of the abnormality with respect to the log using the model in which the normal operation has been learned based on the past normal log. Based on the detection result and the login history, the identification unit 103 identifies the meaning indicated by the abnormality for the login related to the abnormality. Then, the output unit 104 outputs the login related to the abnormality and the meaning indicated by the abnormality in association with each other. A monitoring person who monitors an abnormality such as unauthorized access to the network device 90 may want to grasp a reason why the abnormality is detected. Since the abnormality detection device 10 outputs the meaning indicated by the identified abnormality in association with the login related to the abnormality, it is possible to present the reason why the abnormality is detected. That is, in a case where an abnormality is detected, the monitoring person can grasp the meaning indicated by the abnormality.

Since the analysis unit 102 acquires the detection result of the abnormality with respect to the log by using the machine learning model in which the normal operation is learned, for example, it is possible to reduce the number of abnormalities to be detected as compared with the abnormality detection by the rule-based collation. In the rule-based collation, there may be a case where an access to the network device 90 is detected as abnormal, but there is no problem in practice. If an abnormality is detected even for such an access, the monitoring burden on the monitoring person of the network device 90 may increase. However, in the abnormality detection device 10, the analysis unit 102 acquires the detection result of the abnormality with respect to the log using the machine learning model in which the normal operation is learned. Specifically, the analysis unit 102 acquires the detection result of the abnormality related to at least one detection method among the command pattern, the variable related to the login, and the frequency of the operation. Therefore, it is possible to reduce the possibility of detecting an access without a problem as an abnormality as described above. That is, the monitoring burden on the monitoring person of the network device 90 can be reduced.

In the abnormality detection device 10 according to the present example embodiment, the identification unit 103 includes the meaning identification unit 1031 that identifies the meaning indicated by the abnormality associated with the classification condition satisfied by the log for the classification condition for classifying the abnormality. The meaning indicated by the abnormality includes input of a command different from usual, login using a value different from usual, command input at a frequency different from usual, frequent login attempts, and suspected monitoring interference. The monitoring person of the network device 90 may take time and effort to analyze the detection reason and the like in order to grasp the reason why the abnormality is detected. However, since the meaning identification unit 1031 identifies the meaning indicated by the abnormality including input of a command different from usual, login using a value different from usual, command input at a frequency different from usual, frequent login attempts, and suspected monitoring interference, it is possible to reduce the labor of the monitoring person of the network device 90.

In the abnormality detection device 10 according to the present example embodiment, the identification unit 103 includes the history identification unit 1032 that uses the parameter narrowed down by the classification condition satisfied by the log to search the login related to the abnormality from the login history. By the history identification unit 1032 identifying a login related to an abnormality, for example, monitoring of the network device 90 can grasp which login is associated with the detected abnormality. For example, in a case where an abnormality is detected with respect to the input command, the login of the user who input the command is included in the login history. Therefore, the history identification unit 1032 can identify the login of the user who has input the command in which the abnormality is detected as the login related to the abnormality. That is, the monitoring person of the network device 90 can grasp which login is performed by the user who inputs the command in which the abnormality is detected.

### Second Example Embodiment

The present example embodiment will be described in detail with reference to the drawings. Hereinafter, the description of content overlapping with the above description will be omitted to the extent that description of the present example embodiment is not unclear.

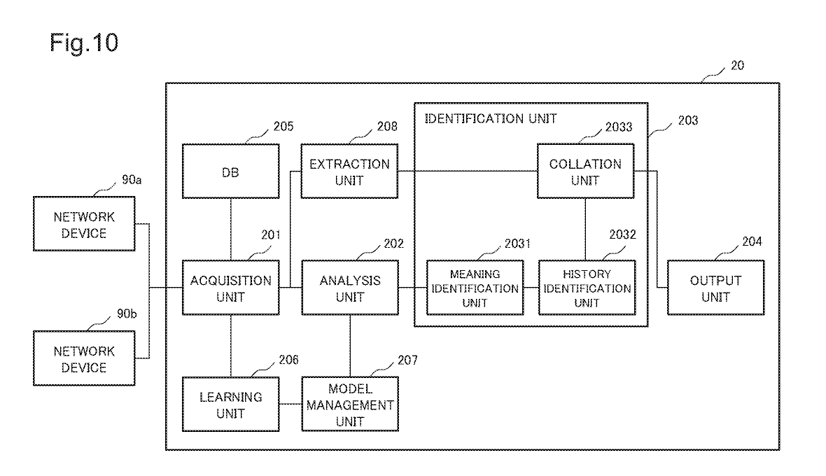

A configuration of an abnormality detection device 20 will be described with reference to FIG. 10. FIG. 10 is a second block diagram illustrating an example of a configuration of a system including the abnormality detection device.

The abnormality detection device 20 according to the present example embodiment includes an extraction unit 208 as compared with the abnormality detection device 10 according to the above-described example embodiment. The identification unit 203 further includes a collation unit 2033. The acquisition unit 201, the analysis unit 202, the identification unit 203, the meaning identification unit 2031, the history identification unit 2032, the output unit 204, the database 205, the learning unit 206, and the model management unit 207 in the abnormality detection device 20 are related to the acquisition unit 101, the analysis unit 102, the identification unit 103, the meaning identification unit 1031, the history identification unit 1032, the output unit 104, the database 105, the learning unit 106, and the model management unit 107 in the abnormality detection device 10.

The extraction unit 208 is one aspect of an extraction means for extracting a login that does not satisfy login criteria registered in advance from the login history. The extraction unit 208 extracts a login that does not satisfy the login criteria from the login history included in the log to be detected acquired by the acquisition unit 201. The login criteria include at least one of a login plan, a registered user, and a registered access source. Then, the extraction unit 208 identifies a warning type for the login according to a login criterion that does not satisfy the login. Specifying the warning type means, for example, identifying the type of warning to be issued to the monitoring person of the network device 90.

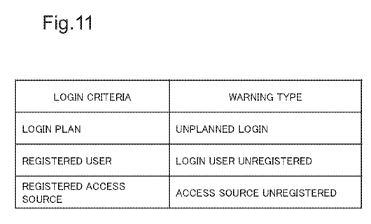

Login criteria and warning types will be described with reference to FIG. 11. FIG. 11 is a diagram illustrating an example of login criteria and warning types. As described above, the login criteria include at least one of a login plan, a registered user, and a registered access source.

First, the login plan includes a scheduled login time and a user name. That is, the login plan is a plan indicating when and who logs in. The extraction unit 208 extracts logins not included in the login plan in the login history. Then, the warning type in a case where the login plan as the login criteria is not satisfied is “unplanned login”. That is, the extraction unit 208 can identify that the type of warning for login that is not included in the login plan is “unplanned login”.

The registered user is a user registered in advance as a user who can log in to the network device 90. The registered user is, for example, a user name registered in advance. The extraction unit 208 extracts logins by users not included in the registered users in the login history. Then, the warning type in a case where the registered user serving as the login criterion is not satisfied is “login user unregistered”. That is, the extraction unit 208 can identify that the type of warning about login by a user who is not included in the registered users is “login user unregistered”.

The registered access source is an access source registered in advance when the access source is an access source that can log in to the network device 90. The registered access source is, for example, an IP address registered in advance. The extraction unit 208 extracts logins from access sources not included in registered access sources in the login history. Then, the warning type in a case where the registered access source serving as the login criterion is not satisfied is “access source unregistered”. That is, the extraction unit 208 can identify that the type of warning about login from an access source not included in the registered access sources is “access source unregistered”.

The name of the warning type is not limited to the above example. The name of the warning type may be a name indicating a login criterion that does not satisfy login. The login criteria are not limited thereto. The login criteria are determined in advance by, for example, a monitoring person of the network device 90. The login criteria may be changed as needed. For example, a monitoring person of the network device 90 may register a new login plan or delete a registered user. The warning type is not limited to these examples.

The extraction unit 208 outputs, as an extraction result, a login history from which logins that do not satisfy the login criteria are extracted. A login history from which logins that do not satisfy the login criteria are extracted is referred to as an extracted login list. The extracted login list includes warning types. That is, the extracted login list includes warning types for logins included in the extracted login list.

The identification unit 203 further includes the collation unit 2033.

The collation unit 2033 is one aspect of a collation means for collating the login related to the abnormality with the login that does not satisfy the login criteria to determine the degree of priority of the login that does not satisfy the login criteria. The collation unit 2033 acquires the identified login list from the history identification unit 2032. The collation unit 2033 acquires the extracted login list from the extraction unit 208. The collation unit 2033 collates the acquired identified login list and extracted login list. Then, the collation unit 2033 determines the degree of priority of login that does not satisfy the login criteria. Here, the degree of priority is the priority of display. That is, the collation unit 2033 can determine which login is preferentially displayed among logins that do not satisfy the login criteria.

The collation unit 2033 can determine that the degree of priority of logins included in the identified login list among logins included in the extracted login list is high. That is, the collation unit 2033 can determine that the degree of priority is high for the login that does not satisfy the login criteria and is related to the abnormality.

The collation unit 2033 can determine that the degree of priority of logins not included in the identified login list among logins included in the extracted login list is low. That is, the collation unit 2033 can determine that the degree of priority is low for logins that do not satisfy the login criteria but are not logins related to abnormality.

The way of indicating the degree of priority is not limited to “high” and “low”. The degree of priority may be represented by, for example, a rank or a numerical value. A flag may be given to a login with a high degree of priority.

The output unit 204 outputs the login that does not satisfy the login criteria and the degree of priority in association with each other. Then, the output unit 204 outputs the meaning indicated by the abnormality in association with the login related to the abnormality among the logins not satisfying the login criteria. The output unit 204 may display logins that do not satisfy the login criteria in order according to the degree of priority.

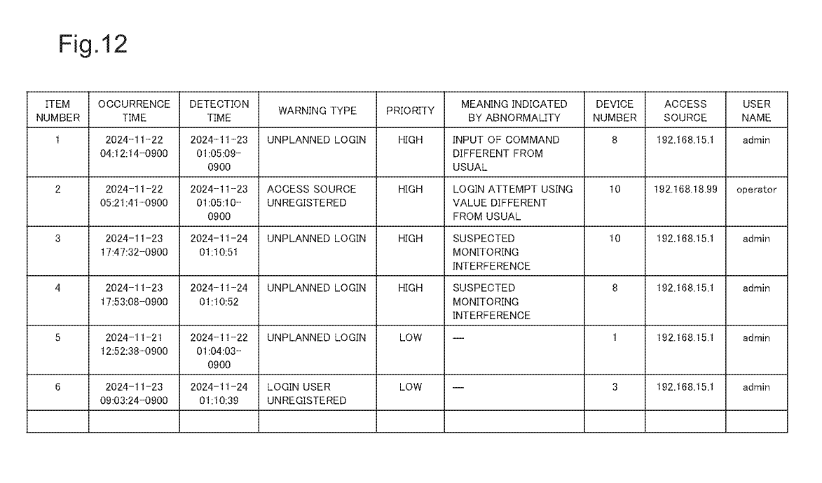

An example of a screen on which logins that do not satisfy the login criteria and the degree of priority are displayed in association with each other will be described with reference to FIG. 12. Here, the output destination by the output unit 204 is as described above. FIG. 12 is a diagram illustrating an example of a screen on which logins that do not satisfy login criteria and the degree of priority displayed in association with each other. Description of parts similar to those of the screen example illustrated in FIG. 8 will be omitted. In FIG. 12, information regarding six logins is displayed as logins that do not satisfy the login criteria. Then, a warning type and priority are displayed for each login. That is, the login that does not satisfy the login criteria and the degree of priority are displayed in association with each other. The priority is an example of the degree of priority. The occurrence time, the detection time, the meaning indicated by the abnormality, the device number, the access source, and the user name are similar to those in FIG. 8.

In the example of FIG. 12, logins of item numbers 1 to 4 have high priority. That is, logins of item numbers 1 to 4 are logins that do not satisfy the login criteria and are related to abnormality. Therefore, for logins of item numbers 1 to 4, meanings indicated by abnormalities of the logins are displayed. On the other hand, logins of item numbers 5 and 6 have low priority. That is, the logins of item numbers 5 and 6 are logins that do not satisfy the login criteria but are not logins related to abnormality. Therefore, the meaning indicated by the abnormality is not displayed for logins of item numbers 5 and 6. For the login with low priority, the display method of the column of the meaning indicated by the abnormality may be, for example, display such as “N/A”. For logins that do not meet the login criteria, the displayed information is not limited thereto.

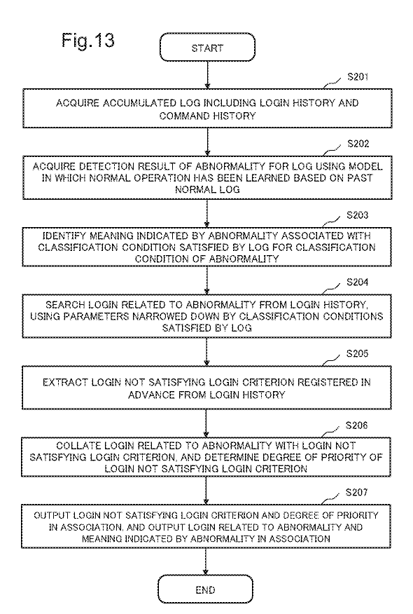

The operation of the abnormality detection device 20 including the acquisition unit 201, the analysis unit 202, the meaning identification unit 2031, the history identification unit 2032, the collation unit 2033, the output unit 204, and the extraction unit 208 will be described with reference to FIG. 13. FIG. 13 is a second flowchart illustrating an example of the operation of the abnormality detection device.

Steps S201 to S204 are similar to steps S101 to S104 in FIG. 9. In step S205, the extraction unit 208 extracts a login that does not satisfy the login criteria registered in advance from the login history. In step S206, the collation unit 2033 collates the login related to the abnormality with the login that does not satisfy the login criteria, and determines the degree of priority of the login that does not satisfy the login criteria. In step S207, the output unit 204 outputs the login that does not satisfy the login criteria and the degree of priority in association with each other, and outputs the login related to the abnormality and the meaning indicated by the abnormality in association with each other. Then, the abnormality detection device 20 ends the operation. Here, in step S202, the analysis unit 202 can acquire an abnormality detection result for a plurality of detection methods. The abnormality detection device 20 may repeat the processing of the flowchart exemplified in FIG. 13 for each of the plurality of detection methods.

The order of the operations from step S202 to step S204 and the operation of step S205 is not limited. After the operation of step S205, the operations from step S202 to step S204 may be performed. The operations from step S202 to step S204 and the operation of step S205 may be performed in parallel. That is, the operations from step S202 to step S204 and the operation of step S205 may be performed by the time the operation of step S205 is performed.

In the abnormality detection device 20 according to the present example embodiment, the extraction unit 208 extracts a login that does not satisfy the login criteria registered in advance from the login history. Then, the identification unit 203 further includes a collation unit 2033 that collates the login related to the abnormality with the login that does not satisfy the login criteria and determines the degree of priority of the login that does not satisfy the login criteria. Logins extracted using login criteria may include logins that do not actually cause a problem. Therefore, the collation unit 2033 determines the degree of priority of login that does not satisfy the login criteria, so that it is possible to determine whether the login extracted using the login criteria is highly likely to be abnormal. Then, the output unit 204 outputs the login that does not satisfy the login criteria and the degree of priority in association with each other, so that the monitoring person of the network device 90 can confirm whether the login extracted using the login criteria is highly likely to be abnormal.

### Third Example Embodiment

The present example embodiment will be described in detail with reference to the drawings. Hereinafter, the description of content overlapping with the above description will be omitted to the extent that description of the present example embodiment is not unclear.

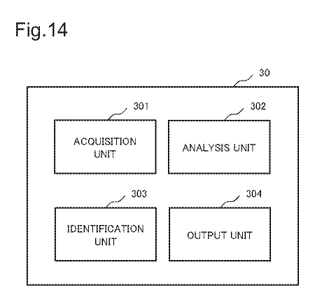

A configuration of an abnormality detection device 30 will be described with reference to FIG. 14. FIG. 14 is a block diagram illustrating an example of a configuration of the abnormality detection device. The abnormality detection device 30 includes an acquisition unit 301, an analysis unit 302, a identification unit 303, and an output unit 304.

The acquisition unit 301 is one aspect of an acquisition means for acquiring a log including the accumulated login history and command history. The login history is a record of information regarding login. The login history includes, for example, login time, information for identifying the network device 90 that has logged in, and information regarding login such as a login result, a user name, and an access source. The command history is a record of information regarding a command input to the network device 90. The command history includes, for example, command input time, information for identifying network device 90 that has input the command, and information regarding the command such as a command content. The acquisition unit 301 can acquire, for example, a log including the login history and the command history accumulated in the database 205.

The analysis unit 302 is one aspect of an analysis means for acquiring a detection result of an abnormality with respect to a log using a model in which a normal operation has been learned based on a past normal log. The analysis unit 302 uses a machine learning model in which a normal operation has been learned. The past normal log is a log obtained by removing a log in which an abnormality has occurred from the accumulated past log. The model is a model learned for each of a command pattern, a variable related to login, and a frequency of operation as an abnormality detection method. The analysis unit 302 inputs the log of the abnormality detection target acquired by the acquisition unit 301 to the model. Then, the analysis unit 302 acquires the detection result of the abnormality related to at least one detection method among the command pattern, the variable related to the login, and the frequency of the operation.

The identification unit 303 is one aspect of a identification means for identifying the meaning indicated by the abnormality for the login related to the abnormality based on the detection result and the login history. In a case where an abnormality is detected, the identification unit 303 identifies the meaning indicated by the abnormality. The identification unit 303 identifies login related to the detected abnormality. Here, the meaning indicated by the abnormality includes input of a command different from usual, login using a value different from usual, command input at a frequency different from usual, frequent login attempts, and suspected monitoring interference.

The output unit 304 is one aspect of an output means for outputting the login related to the abnormality and the meaning indicated by the abnormality in association with each other. The output unit 304 outputs the login related to the abnormality identified by the identification unit 303 and the meaning indicated by the abnormality in association with each other. For example, in a case where the abnormality detection device 30 has a display function, the output unit 304 can display the login related to the abnormality and the meaning indicated by the abnormality in association with each other. In a case where the abnormality detection device 30 is connected to a display device such as a display, the output unit 304 may output the login related to the abnormality and the meaning indicated by the abnormality in association with each other to the display device. In addition, the output unit 304 may output the login related to the abnormality and the meaning indicated by the abnormality in association with each other to an information processing device different from the abnormality detection device 30. The output destination by the output unit 304 is not limited thereto.

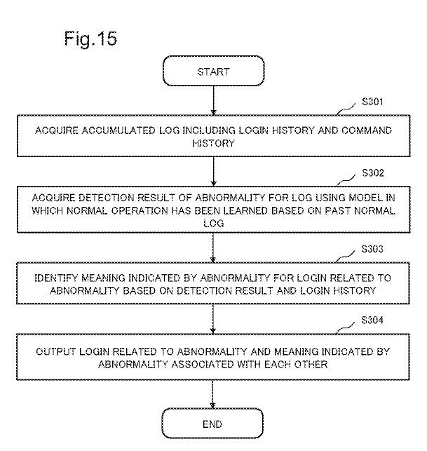

The operation of the abnormality detection device 30 including the acquisition unit 301, the analysis unit 302, the identification unit 303, and the output unit 304 will be described with reference to FIG. 15. FIG. 15 is a third flowchart illustrating an example of the operation of the abnormality detection device. In step S301, the acquisition unit 301 acquires a log including the accumulated login history and command history. In step S302, the analysis unit 302 acquires the detection result of the abnormality with respect to the log using the model in which the normal operation has been learned based on the past normal log. In step S303, the identification unit 303 identifies the meaning indicated by the abnormality for the login related to the abnormality based on the detection result and the login history. In step S304, the output unit 304 outputs the login related to the abnormality and the meaning indicated by the abnormality in association with each other. Then, the abnormality detection device 30 ends the operation.

In the abnormality detection device 30 according to the present example embodiment, the analysis unit 302 acquires the detection result of the abnormality with respect to the log using the model in which the normal operation has been learned based on the past normal log. Based on the detection result and the login history, the identification unit 303 identifies the meaning indicated by the abnormality for the login related to the abnormality. Then, the output unit 304 outputs the login related to the abnormality and the meaning indicated by the abnormality in association with each other. A monitoring person who monitors an abnormality such as unauthorized access to the network device 90 may want to grasp a reason why the abnormality is detected. Since the abnormality detection device 30 outputs the meaning indicated by the identified abnormality in association with the login related to the abnormality, it is possible to present the reason why the abnormality is detected. That is, in a case where an abnormality is detected, the monitoring person can grasp the meaning indicated by the abnormality.

### Hardware Configuration Example

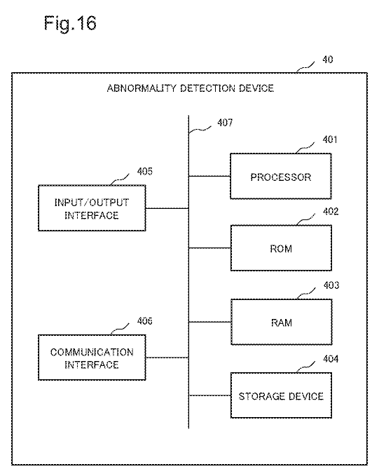

FIG. 16 is a diagram illustrating an example of a hardware configuration of the abnormality detection device. An abnormality detection device 40 is implemented by a computer. The abnormality detection device 40 is an example in a case where the abnormality detection device 10, the abnormality detection device 20, or the abnormality detection device 30 is implemented by a computer.

The abnormality detection device 40 includes a processor 401, a read only memory (ROM) 402, a random access memory (RAM) 403, a storage device 404 such as a hard disk that stores a program, an input/output interface 405 that inputs and outputs data, and a communication interface 406 for network connection. The components are connected via a bus 407.

The processor 401 operates an operating system to control the entire computer. Examples of the processor 401 include a central processing unit (CPU), a digital signal processor (DSP), and a graphics processing unit (GPU). The processor 401 loads a program stored in, for example, the ROM 402, the storage device 404, or the like. Then, the processor 401 executes each processing coded in the program. The processor 401 may execute processing or instructions in the illustrated flowchart based on a program.

The ROM 402 stores an application program, a program according to each example embodiment, and the like. The RAM 403 is used as a work area of the processor 401.

Examples of the storage device 404 include a semiconductor memory such as a flash memory, a hard disk drive (HDD), and the like. The storage device 404 stores, for example, an operating system (OS) program, an application program, a program according to each example embodiment, and the like.

The input/output interface 405 is connected to a peripheral apparatus (not illustrated). The connection method may be a wired network or a wireless network.

The communication interface 406 is connected to a communication network (not illustrated) such as a local area network (LAN) or a wide area network (WAN) through a wireless or wired network. The communication network may include a plurality of communication networks. As a result, the computer is connected to an external device via the communication network. The abnormality detection device 40 may include components other than those illustrated in FIG. 16. For example, the abnormality detection device 40 may include a drive device or the like. For example, the processor 401 may be mounted on a drive device or the like, and may read a program or data stored in a non-transitory tangible recording medium into the RAM 403.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments can also be described as the following Supplementary Notes, but are not limited to the following.

(Supplementary Note 1)

An abnormality detection device including: an acquisition means for acquiring a log accumulated including a login history and a command history;
an analysis means for acquiring a detection result of an abnormality in the log by using a model in which a normal operation has been learned based on a past normal log;
a identification means for identifying a meaning indicated by the abnormality for login related to the abnormality based on the detection result and the login history; and
an output means for outputting the login related to the abnormality and the meaning indicated by the abnormality in association with each other.

(Supplementary Note 2)

The abnormality detection device according to Supplementary Note 1, wherein the identification means includes
a meaning identification means for identifying the meaning indicated by the abnormality associated with a classification condition satisfied by the log, the classification condition classifying the abnormality.

(Supplementary Note 3)

The abnormality detection device according to Supplementary Note 2, wherein

the identification means further includes

a history identification means for searching the login history for the login related to the abnormality by using a parameter narrowed down by the classification condition satisfied by the log.

(Supplementary Note 4) Wording consideration

The abnormality detection device according to any one of Supplementary Notes 1 to 3, wherein

the meaning indicated by the abnormality includes input of a command different from usual, login using a value different from usual, command input at a frequency different from usual, frequent login attempts, and suspected monitoring interference.

(Supplementary Note 5)

The abnormality detection device according to any one of Supplementary Notes 1 to 4, further including

an extraction means for extracting a login not satisfying a login criterion registered in advance from the login history, wherein

the identification means further includes

a collation means for collating logins related to the abnormality with the login not satisfying the login criterion to determine a degree of priority of the login not satisfying the login criterion.

(Supplementary Note 6)

The abnormality detection device according to Supplementary Note 5, wherein

the output means outputs the login not satisfying the login criterion and the degree of priority in association with each other.

(Supplementary Note 7)

The abnormality detection device according to any one of Supplementary Notes 1 to 6, wherein

the analysis means acquires the detection result of the abnormality related to at least one detection method of a command pattern, a variable related to login, and a frequency of operation.

(Supplementary Note 8)

An abnormality detection system including:
an acquisition means for acquiring a log accumulated including a login history and a command history;
an analysis means for acquiring a detection result of an abnormality in the log by using a model in which a normal operation has been learned based on a past normal log;
a identification means for identifying a meaning indicated by the abnormality for login related to the abnormality based on the detection result and the login history; and
an output means for outputting the login related to the abnormality and the meaning indicated by the abnormality in association with each other.

(Supplementary Note 9)

An abnormality detection method including: acquiring a log accumulated including a login history and a command history;
acquiring a detection result of an abnormality in the log by using a model in which a normal operation has been learned based on a past normal log;
identifying a meaning indicated by the abnormality for login related to the abnormality based on the detection result and the login history; and
outputting the login related to the abnormality and the meaning indicated by the abnormality in association with each other.

(Supplementary Note 10)

A program for causing a computer to execute processing of:
acquiring a log accumulated including a login history and a command history;
acquiring a detection result of an abnormality in the log by using a model in which a normal operation has been learned based on a past normal log;
identifying a meaning indicated by the abnormality for login related to the abnormality based on the detection result and the login history; and
outputting the login related to the abnormality and the meaning indicated by the abnormality in association with each other.

(Supplementary Note 11)

A recording medium storing a program for causing a computer to execute processing of:
acquiring a log accumulated including a login history and a command history;
acquiring a detection result of an abnormality in the log by using a model in which a normal operation has been learned based on a past normal log;
identifying a meaning indicated by the abnormality for login related to the abnormality based on the detection result and the login history; and
outputting the login related to the abnormality and the meaning indicated by the abnormality in association with each other.

Some or all of the configurations described in Supplementary Notes 2 to 7 dependent on the above-described Supplementary Note 1 can also be dependent on Supplementary Notes 8 to 11 by the dependency relationship similar to that of Supplementary Notes 2 to 9. Furthermore, some or all of the configurations described as the Supplementary Notes can be similarly dependent on not only the Supplementary Notes 1, and 8 to 11, but also various pieces of hardware and software, and various recording devices or systems for recording software without departing from the above-described example embodiments.

An example of an effect of the present disclosure is that a reason why an abnormality is detected can be presented.

The previous description of embodiments is provided to enable a person skilled in the art to make and use the present disclosure. Moreover, various modifications to these example embodiments will be readily apparent to those skilled in the art, and the generic principles and identified examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An abnormality detection device comprising:
at least one memory storing instructions; and
at least one processor configured to execute the instructions to:
acquire a log accumulated including a login history and a command history;
acquire a detection result of an abnormality in the log by using a model in which a normal operation has been learned based on a past normal log;
identify a meaning indicated by the abnormality for login related to the abnormality based on the detection result and the login history; and
output the login related to the abnormality and the meaning indicated by the abnormality in association with each other.

2. The abnormality detection device according to claim 1,
wherein the at least one processor is further configured to execute the instructions to:
identify the meaning indicated by the abnormality associated with a classification condition satisfied by the log, the classification condition classifying the abnormality.

3. The abnormality detection device according to claim 2,
wherein the at least one processor is further configured to execute the instructions to:
search the login history for the login related to the abnormality by using a parameter narrowed down by the classification condition satisfied by the log.

4. The abnormality detection device according to claim 1,
wherein the meaning indicated by the abnormality includes input of a command different from usual, login using a value different from usual, command input at a frequency different from usual, frequent login attempts, and suspected monitoring interference.

5. The abnormality detection device according to claim 1,
wherein the at least one processor is further configured to execute the instructions to:
extract a login not satisfying a login criterion registered in advance from the login history, and
determine a degree of priority of the login not satisfying the login criterion by collating logins related to the abnormality with the login not satisfying the login criterion.

6. The abnormality detection device according to claim 5,
wherein the at least one processor is further configured to execute the instructions to:
output the login not satisfying the login criterion and the degree of priority in association with each other.

7. The abnormality detection device according to claim 1,
wherein the at least one processor is further configured to execute the instructions to:
acquire the detection result of the abnormality related to at least one detection method of a command pattern, a variable related to login, and a frequency of operation.

8. An abnormality detection method comprising:
acquiring a log accumulated including a login history and a command history;
acquiring a detection result of an abnormality in the log by using a model in which a normal operation has been learned based on a past normal log;
identifying a meaning indicated by the abnormality for login related to the abnormality based on the detection result and the login history; and
outputting the login related to the abnormality and the meaning indicated by the abnormality in association with each other.

9. A non-transitory recording medium storing a program for causing a computer to execute:
acquiring a log accumulated including a login history and a command history;
acquiring a detection result of an abnormality in the log by using a model in which a normal operation has been learned based on a past normal log;
identifying a meaning indicated by the abnormality for login related to the abnormality based on the detection result and the login history; and
outputting the login related to the abnormality and the meaning indicated by the abnormality in association with each other.
